(19) United States
(12) Patent Application Publication
(10) Pub. No.: US 2013/0103572 A1
(43) Pub. Date: Apr. 25, 2013

(54) Systems and Methods For Facilitating Debt Reduction

(71) Applicant: Unifund Corporation, Cincinnati, OH (US)

(72) Inventor: David G. Rosenberg, Cincinnati, OH (US)

(73) Assignee: Unifund Corporation, Cincinnati, OH (US)

(21) Appl. No.: 13/654,716

(22) Filed: Oct. 18, 2012

Related U.S. Application Data
(60) Provisional application No. 61/548,872, filed on Oct. 19, 2011.

(51) Int. Cl. G06Q 40/00

(52) U.S. Cl. 705/38

(57) ABSTRACT

Systems and methods for facilitating debt reduction are disclosed. A method includes automatically determining that an incentive participant has successfully completed an incentive activity, automatically determining the debt account for which the outstanding balance will be reduced as a result of the successful completion of the incentive activity by the incentive participant, automatically determining a debt reduction amount greater than an amount of money to be actually paid to the debt owner or debt collector as a result of the incentive participant successfully completing the incentive activity, and automatically facilitating the reduction of the outstanding balance of the debt account by the debt reduction amount.

### CLAIM OF PRIORITY

This application claims the benefit of U.S. Provisional Application No. 61/548,872, entitled “Methods and Systems for Utilizing Defaulted Debt Reduction to Incentivize Behavior,” filed Oct. 19, 2011, the entirety of which is hereby incorporated by reference.

### BACKGROUND

1. Field

The present specification generally relates to systems and methods for facilitating debt reduction and, more particularly, to systems and methods for facilitating a reduction of an outstanding balance on a debt account in a debt reduction incentive program.

2. Technical Background

Credit card companies, financing companies, and other lenders may extend credit to debtors who are obligated to repay the money borrowed at a later date. In some cases, a lender may choose to retain the right to receive payment from the debtor and may seek to collect payment from the debtor pursuant to the debtor's debt obligation. In other cases, a lender may choose to sell the debt of the debtor to a third party debt owner and the third party debt owner may seek to collect payment from the debtor pursuant to the debtor's debt obligation. In other cases, either a lender or a third party debt owner may utilize a debt collector (e.g., a debt collection agency), to collect payment from the debtor pursuant to the debtor's debt obligation. Whether a lender attempts to collect payment, a third party debt owner attempts to collect payment, or a debt collector attempt to collect payment, it may prove difficult to collect payments from the debtor in order to reduce the outstanding balance of the debt obligation.

When debtors do not meet their repayment obligations, they may default on the account owed to the lender (the original debt owner). Upon default, the lender may refuse to provide additional credit to the debtor by cancelling or terminating the debtor's account. A lender may also choose to sell the defaulted debt of a debtor to a third party debt owner. In such a transaction, the seller of the debtor's defaulted debt is typically willing to sell the debt for less than the balance owed by the debtor because of the perceived difficulty in collecting the full balance from the debtor. The buyer of the defaulted debt buys the defaulted debt in hopes of making a profit by collecting more of the debt from the debtor than the buyer paid for the debt. Oftentimes it proves difficult for the debt owner or the debt collector to collect payments from the debtor in order to reduce the outstanding balance of the defaulted debt obligation.

Accordingly, a need exists for alternative systems and methods for facilitating debt reduction.

### SUMMARY

In one embodiment, a computer-implemented method of facilitating a reduction of an outstanding balance on a debt account in a debt reduction incentive program includes determining, automatically by a debt reduction facilitation computing system, that an incentive participant has successfully completed an incentive activity. The method further includes determining, automatically by the debt reduction facilitation computing system, the debt account for which the outstanding balance will be reduced as a result of the successful completion of the incentive activity by the incentive participant. The method further includes determining, automatically by the debt reduction facilitation computing system, a debt reduction amount. The debt reduction amount is based on an actual payment amount. The actual payment amount is indicative of an amount of money to be actually paid to the debt owner or debt collector as a result of the incentive participant successfully completing the incentive activity. The debt reduction amount is greater than the actual payment amount. The method further includes facilitating, automatically by the debt reduction facilitation computing system, the reduction of the outstanding balance of the debt account by the debt reduction amount.

In another embodiment, a computer-implemented method for facilitating a reduction of an outstanding balance on a debt account in a debt reduction incentive program includes receiving, automatically by a debt reduction facilitation computing system, debt account data. The method further includes determining, automatically by the debt reduction facilitation computing system, the debt account for which the outstanding balance will be reduced as a result of the successful completion of an incentive activity by the incentive participant based on the received debt account data. The method further includes providing for display, automatically by the debt reduction facilitation computing system, a graphical representation of the incentive activity and a debt reduction amount. The debt reduction amount is based on the actual payment amount. The actual payment amount is indicative of an amount of money to be actually paid to the debt owner or debt collector as a result of the incentive participant successfully completing the incentive activity. The debt reduction amount is greater than the actual payment amount.

In yet another embodiment, a debt reduction facilitation computing system for facilitating a reduction of an outstanding balance on a debt account in a debt reduction incentive program includes a non-transitory memory component storing a set of executable instructions and a processor capable of executing the set of executable instructions. When executed by the processor, the set of executable instructions causes the debt reduction facilitation computing system to automatically determine that an incentive participant has successfully completed an incentive activity, automatically determine the debt account for which the outstanding balance will be reduced as a result of the successful completion of the incentive activity by the incentive participant, and automatically determine a debt reduction amount. The debt reduction amount is based on an actual payment amount. The actual payment amount is indicative of an amount of money to be actually paid to the debt owner or debt collector as a result of the incentive participant successfully completing the incentive activity. The debt reduction amount is greater than the actual payment amount. When executed by the processor, the set of executable instructions further causes the debt reduction facilitation computing system to automatically facilitate the reduction of the outstanding balance of the debt account by the debt reduction amount.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computing network for a debt reduction incentive program, according to one or more embodiments shown and described herein;

FIG. 2 depicts a schematic illustration of the debt reduction facilitation computing system from FIG. 1, further illustrating hardware and software that may be utilized to facilitate debt reduction, according to one or more embodiments shown and described herein;

FIG. 3 depicts a flowchart graphically illustrating a method of facilitating debt reduction, according to one or more embodiments show and described herein;

FIG. 4 depicts a login screen for a debt reduction incentive program website, according to one or more embodiments shown and described herein;

FIG. 5 depicts an account creation screen for a debt reduction incentive program website, according to one or more embodiments shown and described herein;

FIG. 6 depicts an account history screen for a debt reduction incentive program website, according to one or more embodiments shown and described herein;

FIG. 7 depicts an offer presentation screen for a debt reduction incentive program website, according to one or more embodiments shown and described herein; and

FIG. 8 depicts an offer details screen for a debt reduction incentive program website, according to one or more embodiments shown and described herein.

### DETAILED DESCRIPTION

Referring generally to the figures, embodiments described herein are directed to systems and methods for facilitating a reduction of an outstanding balance on a debt account in a debt reduction incentive program. The embodiments described herein are described with reference to a “debt reduction incentive program,” which typically includes a debtor obligated to pay the outstanding balance of the debt account, a debt owner or debt collector seeking to collect payment from the debtor, and an incentive provider. The incentive provider agrees to pay an incentive amount when an incentive participant successfully completes an incentive activity. As a result of the incentive participant successfully completing the incentive activity, an actual payment amount, which is at least a portion of the incentive amount, is paid to the debt owner or debt collector to reduce the outstanding balance of the debt account. According to embodiments described herein, a debt reduction facilitation computing system facilitates the reduction of an outstanding balance of the debt account by a debt reduction amount, which is greater than the actual payment amount, upon completion of the incentive activity by the incentive participant. By facilitating the reduction of an outstanding balance of a debt account by a debt reduction amount that is higher than an actual payment amount as a result of an incentive participant successfully completing an incentive activity, debtors may be motivated to pay off their debt because they may feel like they are receiving a greater benefit than if they only received the actual payment amount in cash or cash equivalents, as may be the case if the debtor participated in an incentive program outside of the debt reduction incentive program provided herein. By facilitating the reduction of an outstanding balance of a debt account by a debt reduction amount that is higher than an actual payment amount as described herein, debtors may benefit by paying off an outstanding balance of a debt account more quickly than if the outstanding balance were merely reduced by the actual payment amount. Furthermore, debtors may benefit from the ability to pay off an outstanding balance of a debt account by engaging in activity (e.g., shopping or signing up for offers), that they may ordinarily engage in. Encouraging debtors to pay off their outstanding debt by reducing the outstanding debt by a payoff amount greater than an actual payment amount may allow debt owners and/or debt collectors to receive more and/or accelerated payments on debt accounts, thereby improving the ability of the debt owners and/or debt collectors to collect outstanding debt. Furthermore, in the context of defaulted debt accounts, in which the debt reduction amount may be significantly higher than the actual payment amount, debtors may be even more motivated to pay off their debt accounts, thereby improving the ability for the debt owner and/or debt collector to collect the defaulted debt. Various embodiments of systems and methods for facilitating a reduction of an outstanding balance on a debt account in a debt reduction incentive program are described below.

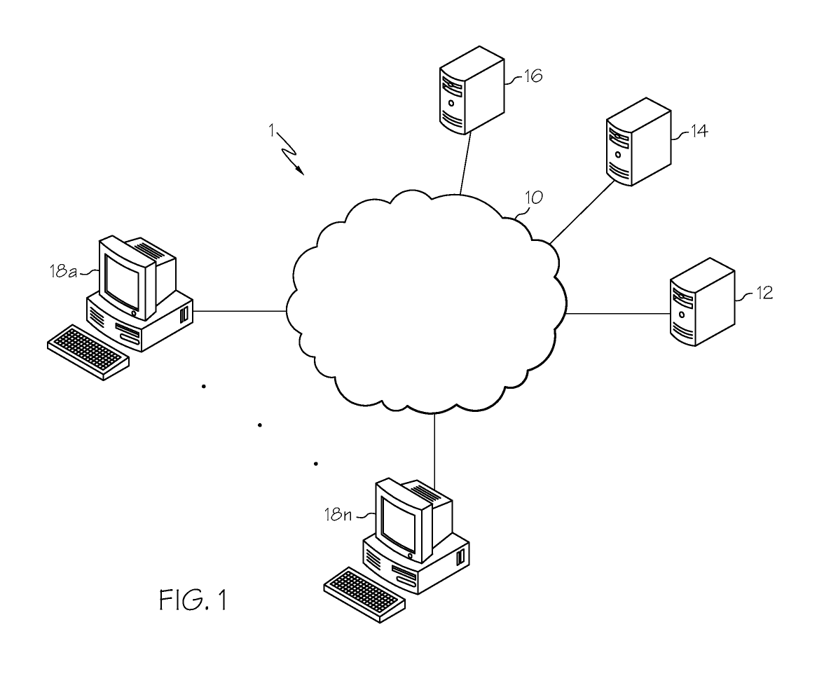

Referring now to the drawings, FIG. 1 depicts an exemplary computing network, illustrating components for a debt reduction incentive program 1, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a debt reduction facilitation computing system 12, an optional incentive provider computing system 14, an optional debt account administration computing system 16, and an optional one or more incentive participant computing systems 18a, . . . , 18n.

In embodiments that include the optional incentive provider computing system 14, the optional incentive provider computing system 14 may enable an incentive participant to complete an incentive activity. In some embodiments, the incentive participant may be a debtor of a debt account. In embodiments in which the incentive participant is the debtor, the debtor may be motivated to pay off at least a portion of the outstanding balance of the debt account by participating in an incentive activity. In other embodiments, the incentive participant may be an associate of the debtor. In embodiments in which the incentive participant is an associate of the debtor, the associate of the debtor may help the debtor pay off at least a portion of the outstanding balance of the debtor's bank account by participating in the incentive activity. The optional incentive provider computing system 14 may also transmit an incentive completion confirmation message and/or an electronic incentive payment to the debt reduction facilitation computing system 12 when the incentive participant completes the incentive activity. The optional incentive provider computing system 14 may also be utilized to perform other functions, such as to administer the incentive activity, collect information from an incentive participant, determine when the incentive activity has been completed, transmit a message including am amount of the incentive payment, and the like. In some embodiments, the optional incentive provider computing system 14 may be operable to administer one or more particular incentive activities. In other embodiments, the optional incentive provider computing system 14 may be operable as an incentive aggregator that may administer incentive activities provided by a plurality of incentive providers. While the embodiment depicted in FIG. 1 includes the optional incentive provider computing system 14, it should be understood that other embodiments do not include the optional incentive provider computing system 14, such as in embodiments that facilitate the reduction of an outstanding balance on a debt account without input from the optional incentive provider computing system 14. The interaction between the optional incentive provider computing system 14 and the debt reduction facilitation computing system 12 will be described in further detail below.

In embodiments that include the optional debt account administration computing system 16, the optional debt account administration computing system 16 may be operable to reduce an outstanding balance of a debt account and/or otherwise administer and service the debt account. In some embodiments, the optional debt account administration computing system 16 may be associated with a debt owner or debt collector, such as in embodiments in which the optional debt account administration computing system 16 receives a debt reduction message from the debt reduction facilitation computing system 12. The optional debt account administration computing system 16 may also be utilized to perform other functions, such as to administer the debt account, adjust the outstanding balance of the debt account, and the like. While the embodiment depicted in FIG. 1 includes the optional debt account administration computing system 16, it should be understood that other embodiments do not include the optional debt account administration computing system 16, such as in embodiments in which the debt reduction facilitation computing system 12 directly reduces the outstanding balance of the debt account. The interaction between the optional debt account administration computing system 16 and the debt reduction facilitation computing system 12 will be described in further detail below.

In embodiments that include the optional one or more incentive participant computing systems 18a, . . . , 18n, the one or more incentive participant computing systems 18a, . . . , 18n may enable one or more incentive participants to participate in and successfully complete one or more incentive activities. In some embodiments, the optional one or more incentive participant computing systems 18a, . . . , 18n may allow a user of the computing system to access a website provided by the debt reduction facilitation computing system 12, as will be described in more detail below, and participate in one or more incentive programs administered by the optional incentive provider computing system 14. While the embodiment depicted in FIG. 1 includes the optional one or more incentive participant computing systems 18a, . . . , 18n, it should be understood that other embodiments do not include the optional one or more incentive participant computing systems 18a, . . . , 18n. The interaction between the optional one or more incentive participant computing systems 18a, . . . , 18n and the debt reduction facilitation computing system 12 will be described in further detail below.

It should be understood that while the optional one or more incentive participant computing systems 18a, . . . , 18n are depicted as personal computers and the debt reduction facilitation computing system 12, the optional incentive provider computing system 14, and the optional debt account administration computing system 16 are depicted as servers, these are nonlimiting examples. More specifically, in some embodiments, any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the debt reduction facilitation computing system 12, the optional incentive provider computing system 14, the optional debt account administration computing system 16, and the optional one or more incentive participant computing systems 18a, . . . , 18n may represent a plurality of computers, servers, databases, etc.

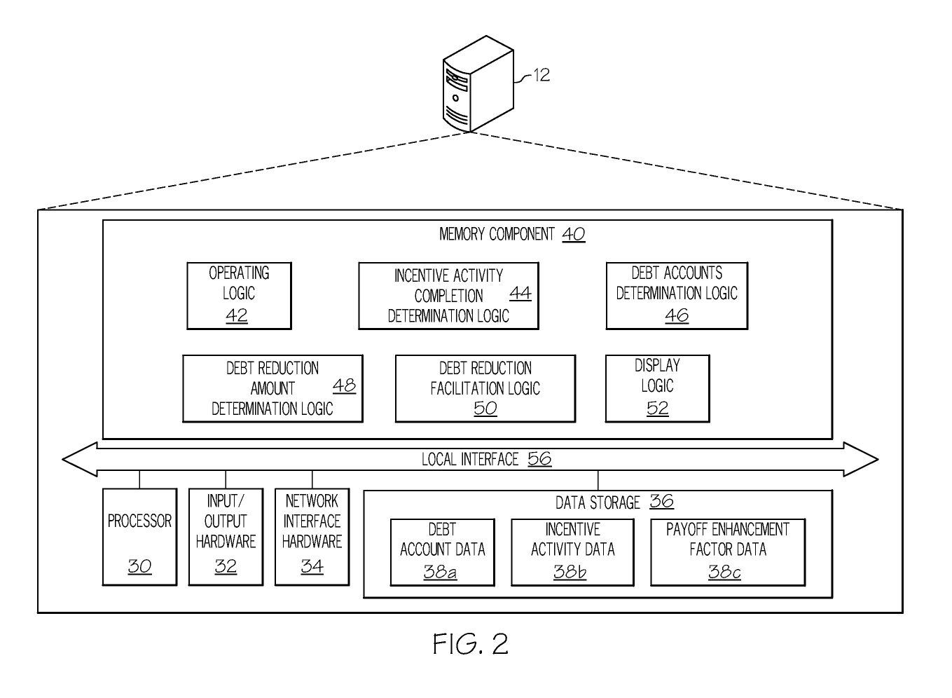

FIG. 2 depicts the debt reduction facilitation computing system 12, from FIG. 1, further illustrating a computing system for facilitating debt reduction, and/or a non-transitory computer-readable medium for facilitating debt reduction, embodied as hardware, software, and/or firmware, according to embodiments shown and described herein. While, in some embodiments, the debt reduction facilitation computing system 12 may be configured as a general purpose computer with the requisite hardware, software, and/or firmware, in some embodiments, the debt reduction facilitation computing system 12 may be configured as a special purpose computer designed specifically for performing the functionality described herein.

As also illustrated in FIG. 2, the debt reduction facilitation computing system 12 may include a processor 30, input/output hardware 32, network interface hardware 34, a data storage component 36 (including debt account data 38a, incentive activity data 38b, and payoff enhancement factor data 38c), and a non-transitory memory component 40. The memory component 40 may be configured as volatile and/or nonvolatile computer readable medium and, as such, may include random access memory (including SRAM, DRAM, and/or other types of random access memory), hard disk drives (HDD), flash memory, registers, compact discs (CD), digital versatile discs (DVD), Blu-Ray discs, and/or other types of storage components. Additionally, the memory component 40 may be configured to store operating logic 42, incentive activity completion determination logic 44, debt account determination logic 46, debt reduction amount determination logic 48, debt reduction facilitation logic 50, and display logic 52 (each of which may be embodied as a computer program, firmware, or hardware, as an example). A local interface 56 is also included in FIG. 2 and may be implemented as a bus or other interface to facilitate communication among the components of the debt reduction facilitation computing system 12.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the debt reduction facilitation computing system 12 and may be configured to store one or more pieces of data for access by the debt reduction facilitation computing system 12 and/or other components. As illustrated in FIG. 2, the data storage component 36 may store debt account data 38a, incentive activity data 38b, and payoff enhancement factor data 38c, each of which may be stored in one or more data storage devices. While the embodiment depicted in FIG. 2 includes debt account data 38a, incentive activity data 38b, and payoff enhancement factor data 38c stored in the data storage component 36, it should be understood that in other embodiments, debt account data, incentive activity data, and payoff enhancement factor data may be received by the debt reduction facilitation computing system 12 in real time and utilized to facilitate the reduction of an outstanding balance on a debt account without accessing the data storage component 36. For example, in some embodiments, the debt reduction facilitation computing system 12 may receive debt account data 38a and/or payoff enhancement factor data 38c from a source external to the debt reduction facilitation computing system 12, such as from the optional debt account administration computing system 16. In some embodiments, the debt reduction facilitation computing system 12 may receive incentive activity data 38b from a source external to the debt reduction facilitation computing system 12, such as from the optional incentive provider computing system 14.

Debt account data 38a may include information pertaining to a plurality of debt accounts. For each debt account or group of debt accounts stored in debt account data 38a, debt account data 38a may include debtor information (e.g., debtor name, debtor address, debtor phone number, debtor Social Security number, debtor identifier, debtor e-mail address, promotional code, and the like), debt owner information (e.g., debt owner name, debt owner address, debt owner identifier, and the like), debt collector information (e.g., debt collector name, debt collector address, debt collector identifier, and the like), debt account number, outstanding balance information, payment information, account age, debt status information (e.g., whether the debt account is in default), and the like. In other embodiments, the debt account data 38a may include more or less information than set forth herein. In some embodiments, debt account data 38a may be received from the optional debt account administration computing system 16. The role of debt account data 38a in the systems and methods for facilitating a reduction of an outstanding balance will be described in greater detail herein.

Incentive activity data 38b may include information pertaining to a plurality of incentive activities. For each incentive activity or group of incentive activities stored in incentive activity data 38b, incentive activity data 38b may include an incentive identifier (e.g., an offer name, an incentive name, etc.), an incentive payment amount (indicative of an amount of money agreed to be paid by an incentive provider when an incentive participant successfully completes the incentive activity), an incentive provider (e.g., a name, website address, etc.), an incentive description, an incentive icon, an incentive confirmation period, and the like. Incentive activities may take a number of forms, such as signing up for a trial subscription to a service (e.g., a magazine subscription, a movie rental service subscription, a television service subscription, a website subscription, etc.), creating a new account (e.g., opening a credit card account, establishing a bank account, establishing a brokerage account, etc.), making a purchase from a particular retailer, making a purchase from a particular manufacturer, using a particular means of payment to make a purchase, etc. The incentive amount may depend on the incentive activity. In some embodiments, the incentive amount associated with an incentive activity may be a fixed amount (e.g., a fixed incentive amount for opening a credit card or subscribing to a television service.). In other embodiments, the incentive amount associated with an incentive activity may be a variable amount (e.g., a percentage of purchases made through a particular retailer or manufacturer). In other embodiments, the incentive activity data 38b may include more or less information than set forth herein. In some embodiments, incentive activity data 38b may be received from the optional incentive provider computing system 14. The role of the incentive activity data 38b in the systems and methods for facilitating a reduction of an outstanding balance will be described in greater detail herein.

Payoff enhancement factor data 38c may include information that may be used to determine a payoff enhancement factor that may be used to calculate a debt reduction amount applied to an outstanding balance of a particular debt account when an incentive activity is successfully completed. In some embodiments, the payoff enhancement factor may be greater than 1, such that a debt account may be reduced by a debt reduction amount greater than an actual payment amount when an incentive activity is successfully completed. In some embodiments, a payoff enhancement factor may be based on at least one of the outstanding balance of the debt account, the debt account, the debtor, the debt owner or debt collector, and a collection status of the debt account. In other embodiments, the payoff enhancement factor data 38c may include more or less information than set forth herein Some embodiments do not include payoff enhancement factor data 38c, such as in embodiments that calculate a payoff enhancement factor in real time. The role of payoff enhancement factor data 38c in the systems and methods for facilitating a reduction of an outstanding balance will be described in greater detail herein.

Included in the memory component 40 are the operating logic 42, the incentive activity completion determination logic 44, the debt account determination logic 46, the debt reduction amount determination logic 48, the debt reduction facilitation logic 50, and the display logic 52. The operating logic 42 may include an operating system and/or other software for managing components of the debt reduction facilitation computing system 12. Similarly, the incentive activity completion determination logic 44 may reside in the memory component 40 and may be configured to determine when an incentive activity has been completed. The debt account determination logic 46 may reside in the memory component 40 and may be configured to determine the debt account for which the outstanding balance should be reduced upon successful completion of the incentive activity. The debt reduction amount determination logic 48 may reside in the memory component 40 and may be configured to determine the debt reduction amount to be applied to the debt account in order to reduce the outstanding balance upon successful completion of the incentive activity. The debt reduction facilitation logic 50 may reside in the memory component 40 and may be configured to facilitate the reduction of the outstanding balance of the debt account. The display logic 52 may be configured to display information to a user of the debt reduction incentive program, such as a website, or the like.

While the embodiment depicted in FIG. 2 includes the operating logic 42, the incentive activity completion determination logic 44, the debt account determination logic 46, the debt reduction amount determination logic 48, the debt reduction facilitation logic 50, and the display logic 52 stored in memory component 40, it should be understood that, in other embodiments, one or more of the operating logic 42, the incentive activity completion determination logic 44, the debt account determination logic 46, the debt reduction amount determination logic 48, the debt reduction facilitation logic 50, and the display logic 52 may not be stored in the memory component 40, such as when other components of the debt reduction incentive program are configured to perform the functionality of one or more of these logic components.

It should be understood that the components illustrated in FIG. 2 are merely exemplary and are not intended to limit the scope of this disclosure. More specifically, while the components in FIG. 2 are illustrated as residing within the debt reduction facilitation computing system 12, this is a nonlimiting example. In some embodiments, one or more of the components may reside external to the debt reduction facilitation computing system 12. Furthermore, one or more of the components depicted in data storage component 36 may be stored in memory component 40 and/or one or more of the modules depicted in memory component 40 may be stored in data storage component 36. Similarly, while FIG. 2 is directed to the debt reduction facilitation computing system 12, other components such as the optional incentive provider computing system 14, the optional debt account administration computing system 16, and the optional one or more incentive participant computing systems 18a, . . . , 18n may include similar hardware, software, and/or firmware. Specifically, each of the optional incentive provider computing system 14, the optional debt account administration computing system 16, and the optional one or more incentive participant computing systems 18a, . . . , 18n may include a processor, input/output hardware, network interface hardware, a data storage component, a memory component, and a local interface, as described above with reference to the components of the debt reduction facilitation computing system 12.

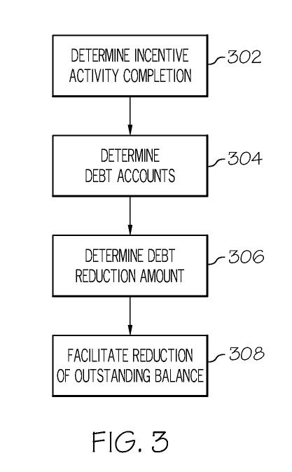

Referring now to FIG. 3 (and FIGS. 1 and 2), a flowchart that graphically illustrates a computer-implemented method of facilitating a reduction of an outstanding balance on a debt account in a debt reduction incentive program according to one or more embodiments is provided. At block 302, the debt reduction facilitation computing system 12 may automatically determine that an incentive participant has successfully completed an incentive activity using the incentive activity completion determination logic 44. The incentive activity completion determination logic 44 verifies that an incentive activity is successfully completed before reducing the outstanding balance of a debt account in order to mitigate the risk of erroneously reducing the outstanding balance of the debt account before the incentive activity is successfully completed (such as in the case when an incentive participant agrees to participate in the incentive activity, but fails to successfully complete the incentive activity).

Still referring to block 302 (and FIGS. 1 and 2), in some embodiments, the incentive activity completion determination logic 44 may be operable to determine the successful completion of the incentive activity by receiving an incentive completion confirmation message at the debt reduction facilitation computing system 12. The incentive completion confirmation message is indicative of the incentive activity being successfully completed. In embodiments that include the optional incentive provider computing system 14, the optional incentive provider computing system 14 may transmit the incentive completion confirmation message. In some embodiments, the incentive completion confirmation message may include the incentive activity, the incentive amount, and/or a unique identifier from which the debt reduction facilitation computing system 12 may determine the incentive activity, the incentive amount, the debt account to be reduced as a result of the successful completion of the incentive activity, etc.

Still referring to block 302 (and FIGS. 1 and 2), in other embodiments, the incentive activity completion determination logic 44 may be operable to determine the successful completion of the incentive activity by receiving an electronic incentive payment at the debt reduction facilitation computing system 12. The electronic incentive payment is indicative of the incentive activity being successfully completed. In embodiments that include the optional incentive provider computing system 14, the optional incentive provider computing system 14 may transmit the electronic incentive payment. In some embodiments, the optional incentive provider computing system 14 may transmit additional information to the debt reduction facilitation computing system 12 from which, when received by the debt reduction facilitation computing system 12, the debt reduction facilitation computing system 12 may determine the incentive activity, the incentive amount, the debt account to be reduced as a result of the successful completion of the incentive activity, etc.

Still referring to FIG. 3 (and FIGS. 1 and 2), at block 304, the debt reduction facilitation computing system 12 may automatically determine the debt account for which the outstanding balance will be reduced as a result of the successful completion of the incentive activity by the incentive participant using the debt account determination logic 46. The debt account determination logic 46 ensures that the outstanding balance of the correct debt account is reduced upon successful completion of the incentive activity to mitigate the risk of reducing the balance of the wrong debt account.

In some embodiments, the debt account determination logic 46 determines the debt account based on information received from the optional incentive provider computing system 14 (e.g., a unique identifier associated with the debt account, or other debt account identification information provided by the optional incentive provider computing system 14) by accessing the debt account data 38a to determine the debt account for which the outstanding balance will be reduced as a result of the successful completion of the incentive activity.

Still referring to FIG. 3 (and FIGS. 1 and 2), at block 306, the debt reduction facilitation computing system 12 may automatically determine a debt reduction amount using the debt reduction amount determination logic 48. The debt reduction amount is based on an actual payment amount. The actual payment amount is indicative of an amount of money to be actually paid to the debt owner or debt collector as a result of the incentive participant successfully completing the incentive activity. The debt reduction amount is greater than the actual payment amount.

In some embodiments, the actual payment amount is equal to the incentive amount agreed to be paid by an incentive provider upon successfully completion of an incentive activity by an incentive participant. In some embodiments, the incentive amount may be a fixed amount agreed to be paid by the incentive provider when the incentive participant successfully completes the incentive activity (e.g., a fixed incentive amount for opening a credit card or subscribing to a television service.). In other embodiments, the incentive amount may be a variable amount (e.g., a percentage of purchases made through a particular retailer or manufacturer). In some embodiments, the incentive amount is received by the debt reduction facilitation computing system 12 (e.g., from the optional incentive provider computing system 14). In other embodiments, the incentive amount is accessed from the data storage component 36 of the debt reduction facilitation computing system 12.

In other embodiments, the actual payment amount is less than the incentive amount, such as in embodiments in which a program administration fee is subtracted from the incentive amount. In such embodiments, the incentive provider may be willing to pay an incentive amount in exchange for an incentive participant successfully completing an incentive activity. In such embodiments, the debt reduction amount may be determined by the debt reduction amount determination logic 48 of the debt reduction facilitation computing system 12 to be the incentive amount less the program administration fee. Embodiments in which the debt reduction amount is less than the incentive amount may benefit both the incentive provider (because the desired incentive activity will be successfully completed by the incentive participant) and the debt owner or debt collector (because the debt owner or debt collector will receive at least a partial payment of the outstanding balance of the debt account).

In some embodiments, the debt reduction amount may exceed the actual payment amount by a payoff enhancement amount. In some embodiments, the payoff enhancement amount is based on at least one of the outstanding balance, the debt account, the debtor, the debt owner or debt collector, and a collection status of the debt account. In some embodiments in which the payoff enhancement amount is based on a collection status of the debt account, the payoff enhancement amount may be greater for debt accounts that have been in default for a long time than for debt accounts that have not been in default for a long time. In other embodiments, in which the payoff enhancement amount is based on a collection status of the debt account, the payoff enhancement amount may be greater for debt accounts that are in default than for debt accounts that are not in default.

In some embodiments, the payoff enhancement amount may be based on the debt owner or debt collector. For example, in one embodiment, a first payoff enhancement amount may apply to debt accounts associated with a first debt owner or debt collector and a second payoff enhancement amount may apply to debt accounts owned associated with a second debt owner or debt collector. In other embodiments, the payoff enhancement amount may be based on the debtor. For example, in one embodiment, a first payoff enhancement amount may apply to a first debt account owed by a first debtor and a second payoff enhancement amount may apply to a second debt account owed by a second debtor.

Still referring to block 306, in some embodiments, the debt reduction amount is determined by multiplying the actual payment amount by a payoff enhancement factor. In some embodiments, the payoff enhancement factor may be accessed from the payoff enhancement factor data 38c. In other embodiments, the payoff enhancement factor may be calculated automatically by the debt reduction facilitation computing system 12 without reference to payoff enhancement factor data stored in the data storage component 36.

In some embodiments, the payoff enhancement factor may be determined based on at least one of the outstanding balance, the debt account, the debtor, the debt owner or debt collector, and a collection status of the debt account. In some embodiments in which the payoff enhancement factor is based on a collection status of the debt account, the payoff enhancement factor may be in the range from about 1.1 to about 1.25 (e.g., in cases where the debt owner or debt collector is willing to accept between about 90 cents per dollar owed and 80 cents per dollar owed, such as for debt accounts that have not been in default long). In other embodiments in which the payoff enhancement factor is based on a collection status of the debt account, the payoff enhancement factor may be in the range from about 5 to about 10 (e.g., in cases where the debt owner or debt collector is willing to accept between about 20 cents per dollar owed and 10 cents per dollar owed), such as for debt account that have been in default for a long time). It should be understood that the payoff enhancement factor may be greater than or less than the ranges set forth herein.

In some embodiments, the payoff enhancement factor may be based on the debt owner or debt collector. For example, in one embodiment, a first payoff enhancement factor may apply to debt accounts associated with a first debt owner or debt collector and a second payoff enhancement factor may apply to debt accounts associated with a second debt owner or debt collector. In other embodiments, the payoff enhancement factor may be based on the debtor. For example, in one embodiment, a first payoff enhancement factor may apply to a first debt account owed by a first debtor and a second payoff enhancement factor may apply to a second debt account owed by a second debtor.

In some embodiments, the debt account may be in default. In such embodiments, the debt reduction amount of the defaulted debt account may be determined by multiplying the actual payment amount by a payoff enhancement factor. In some embodiments, the payoff enhancement factor for debt accounts in default may be higher than the payoff enhancement factor for debt accounts that are not in default.

Still referring to FIG. 3 (and FIGS. 1 and 2), at block 308, the debt reduction facilitation computing system 12 may automatically facilitate the reduction of the outstanding balance of the debt account using the debt reduction facilitation logic 50. In some embodiments, the debt account data 38a stored in the data storage component 36 of the debt reduction facilitation computing system 12 may include the outstanding balance of the debt account. In such embodiments, the debt reduction facilitation logic 50 may retrieve the outstanding balance of the debt account from the debt account data 38a and automatically reduce the outstanding balance. In some embodiments, the reduced outstanding balance may be stored in the debt account data 38a.

Still referring to block 308, the debt reduction facilitation logic 50 of the debt reduction facilitation computing system 12 may automatically facilitate the reduction of the outstanding balance of the debt account by automatically transmitting a debt reduction message after determining that the incentive participant successfully completed the incentive activity. In some embodiments, the debt reduction facilitation computing system 12 transmits the debt reduction message to the optional debt account administration computing system 16, which may receive automatically the transmitted debt reduction message, and automatically reduce the outstanding balance of the debt account in response to receiving the debt reduction message. In some embodiments, the debt reduction message includes: (i) the incentive activity; (ii) the actual payment amount; and/or (iii) the debt reduction amount.

In embodiments in which the debt reduction facilitation computing system 12 receives an incentive completion confirmation, the outstanding balance of the debt account may be reduced in response to receiving the incentive completion confirmation. In embodiments in which the debt reduction facilitation computing system 12 receives an electronic incentive payment, the outstanding balance of the debt account may be reduced in response to receiving the electronic incentive payment.

Although blocks 302-308 have been described as being separate tasks, in other embodiments, the blocks may be combined or omitted. Further, while the tasks of blocks 302-308 have been described as being performed in a particular order, in other embodiments, the tasks may be performed in a different order.

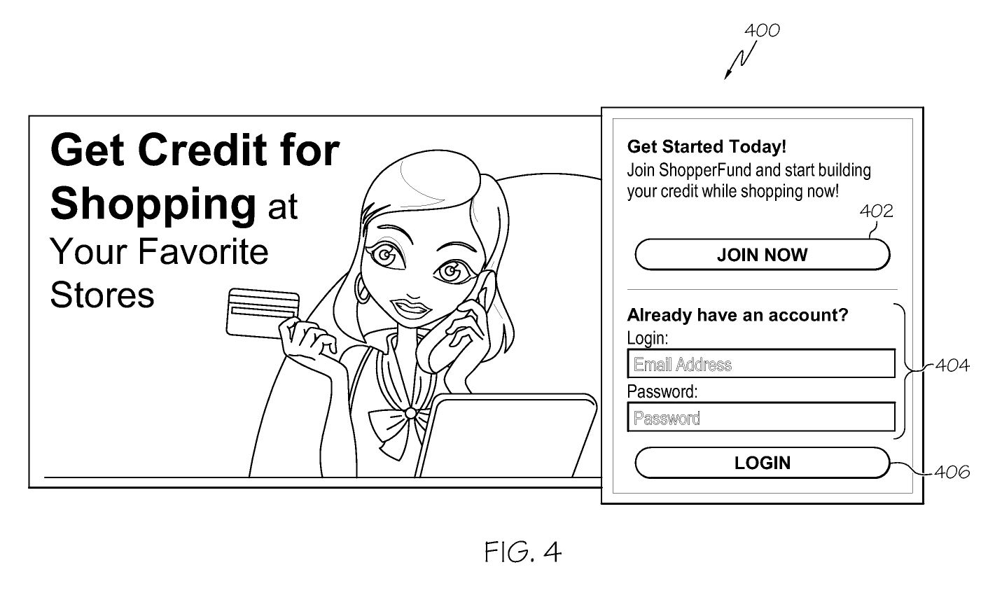

In embodiments in which the debt reduction facilitation computing system 12 includes display logic 52, the display logic 52 may be operable to display a debt reduction incentive website and may contain logic in the memory component 40 to administer the debt reduction incentive website. The debt reduction incentive website described below with reference to FIGS. 4-8 may be accessed by the optional one or more incentive participant computing systems 18a, . . . , 18n. One exemplary debt reduction incentive website will be described below with reference to FIGS. 4-8. However, it should be understood that many other possible debt reduction incentive websites may be utilized in conjunction with the debt reduction facilitation computing system 12 other than what is depicted in FIGS. 4-8 and described below.

Referring now to FIG. 4, a login screen 400 for a debt reduction incentive program website is schematically depicted. The login screen 400 includes a “join now” button 402, which enables a user of the website to create an account and join the debt reduction incentive program. The login screen 400 also includes a login information input portion 404, in which a user may input login information (such as an e-mail address and password) in order to access the debt reduction incentive program website. The login screen 400 includes a “login” button 406, which the user may manipulate in order to login to the website. It should be understood that the login screen 400 may include more or less information and functionality and may be laid out differently than depicted in FIG. 4.

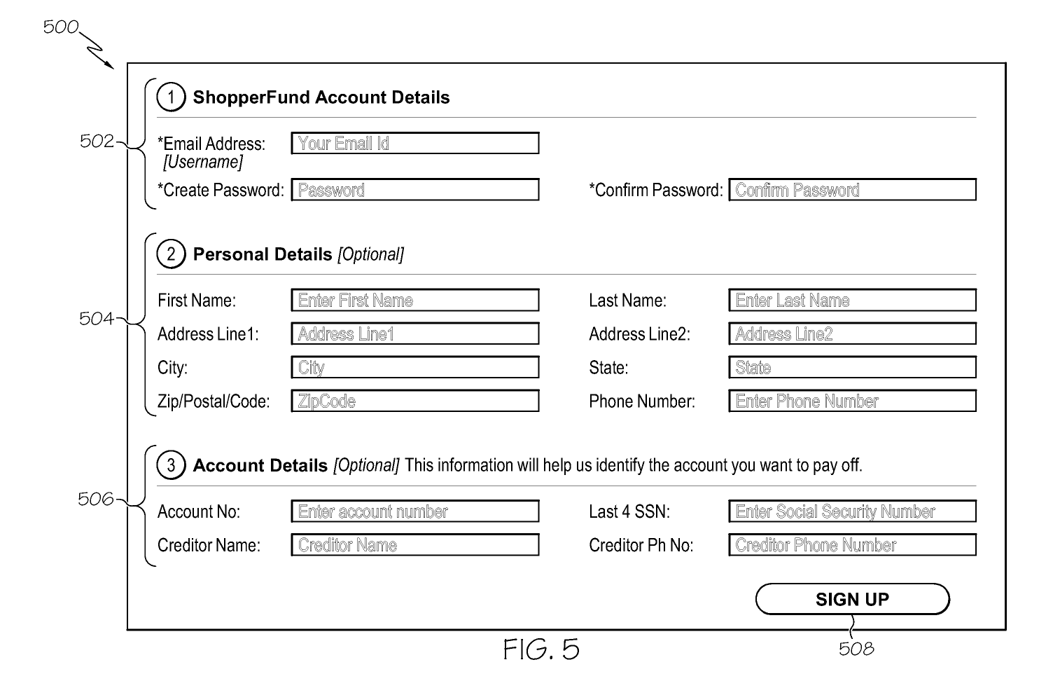

Upon manipulating the “join now” button 402, the user may be presented with an account creation screen 500, as depicted in FIG. 5. The account creation screen 500 includes a debt reduction incentive program account details input section 502 (into which a user may input an e-mail address, a password, etc.), a personal details input section 504 (into which a user may input a name, address, a phone number, etc.), and a debt account details input section 506 (into which a user may input a debt account number, a creditor name, a creditor phone number, personal identifying information (e.g., last four digits of Social Security number), etc.). Once the user has input the desired information into the account creation screen 500, the user may manipulate the “sign up” button 508. In response to the user manipulating the “sign up” button 508, the debt reduction facilitation computing system 12 may create an account for the user and may update debt account data 38a in data storage component 36 to include at least some of the information input by the user into the personal details input section 504 of the debt account details input section 506. It should be understood that the account creation screen 500 may include more or less information and functionality and may be laid out differently than depicted in FIG. 5.

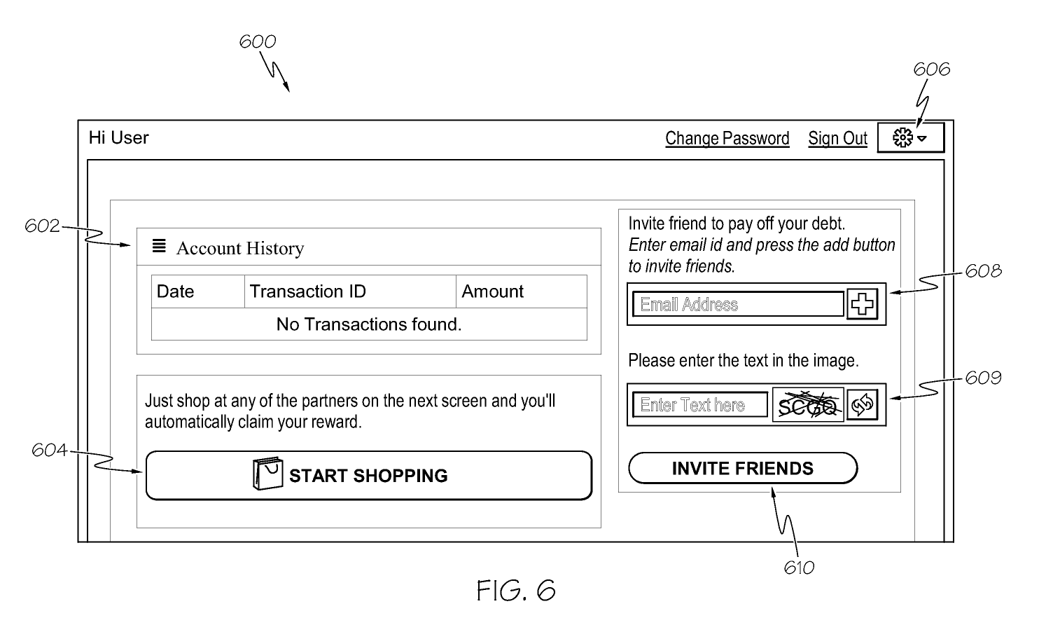

Once a user has an established account, the user may enter login information into the login information input portion 404 and manipulate the “login” button 406, which may cause the user to be presented with an account history screen 600, as depicted in FIG. 6. The account history screen 600 may include an account history portion 602, in which transaction history may be displayed. The account history screen 600 also includes a setting icon 606, which may be manipulated by the user in order to update account settings (e.g., add or edit personal details, debt account details, etc.). The account history screen 600 also includes a “start shopping” button 604, which will allow the user to be presented with a plurality of incentive activities from which to choose. The account history screen also includes a friend invitation portion 608, which allows a user to enter an e-mail address of a friend to be invited to participate in the debt reduction incentive program. Upon the user entering a friend's e-mail address in the friend invitation portion 608, entering the text from the image in the human user verification entry field 609, and manipulating the “invite friends” button 610, an e-mail message may be generated and delivered to the friend. The e-mail message may include a unique link that allows the debt reduction facilitation computing system 12 to determine the debt account to reduce the outstanding balance upon the friend successfully completing one or more incentive activities. It should be understood that the account history screen 600 may include more or less information and functionality and may be laid out differently than depicted in FIG. 6.

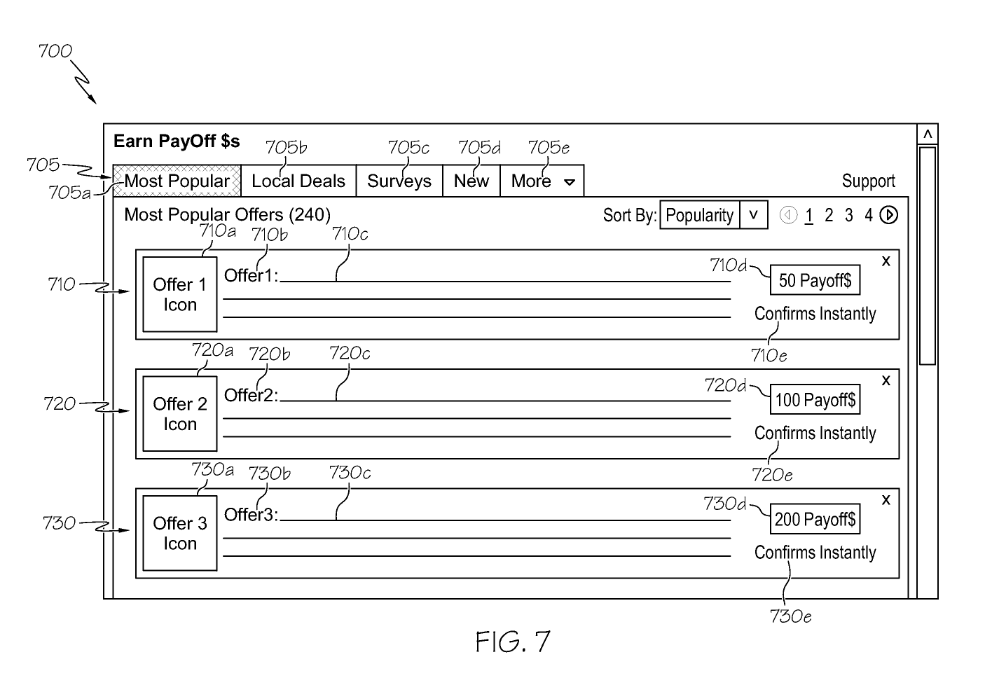

Upon selecting the “start shopping” button 604, the debt reduction facilitation computing system 12 may provide for display an offer presentation screen 700. The offer presentation screen 700 includes a plurality of incentive activities (also referred to herein as offers). The embodiment depicted in FIG. 7 includes a first incentive activity 710, a second incentive activity 720, and a third incentive activity 730. While the embodiment depicted in FIG. 7 displays three incentive activities, it should be understood that in other embodiments more or less than three incentive activities may be displayed.

As depicted in FIG. 7, each incentive activity includes an incentive icon. The embodiment depicted in FIG. 7 includes a first incentive icon 710a (associated with the first incentive activity 710), a second incentive icon 720a (associated with the second incentive activity 720), and a third incentive icon 730a (associated with the third incentive activity 730). In some embodiments, one or more of the displayed incentive activities may not include incentive icons.

As depicted in FIG. 7, each incentive activity also includes a title of the incentive. The embodiment depicted in FIG. 7. The embodiment depicted in FIG. 7 includes a first incentive title 710b (associated with the first incentive activity 710), a second incentive title 720b (associated with the second incentive activity 720), and a third incentive title 730b (associated with the third incentive activity 730). In some embodiments, one or more of the displayed incentive activities may not include incentive titles.

As depicted in FIG. 7, each incentive activity also includes a description of the incentive activity, which may outline the terms that must be completed in order for the incentive activity to be successfully completed. The embodiment depicted in FIG. 7 includes a first incentive description 710c (associated with the first incentive activity 710), a second incentive description 720c (associated with the second incentive activity 720), and a third incentive description 730c (associated with the third incentive activity 730). In some embodiments, one or more of the displayed incentive activities may not include incentive descriptions.

As depicted in FIG. 7, each incentive activity includes a debt reduction amount corresponding to the debt reduction amount associated with the incentive activity and may be determined, as described above with reference to FIG. 3. The embodiment depicted in FIG. 7 includes a first debt reduction amount 710d (associated with the first incentive activity 710), a second debt reduction amount 720d (associated with the second incentive activity 720), and a third debt reduction amount 730d (associated with the third incentive activity 730).

As depicted in FIG. 7, each incentive activity includes an incentive confirmation timing indication, which may communicate to the user how long it takes for the successful completion of the incentive activity to be confirmed (e.g., instantly, 1 day, 2 days, 3 days, one week, one month, one year, etc.) such that the outstanding balance of the debt account is reduced. The embodiment depicted in FIG. 7 includes a first incentive confirmation timing indication 710e (associated with the first incentive activity 710), a second incentive confirmation timing indication 720e (associated with the second incentive activity 720), and a third incentive confirmation timing indication 730e (associated with the third incentive activity 730). In some embodiments, one or more of the displayed incentive activities may not include incentive confirmation timing indication.

Still referring to FIG. 7, the displayed incentive activities may be sorted by categories 705a (most popular), 705b (local deals), 705c (surveys), 705d (new), etc. It should be understood that the offer presentation screen 700 may include more or less information and functionality and may be laid out differently than depicted in FIG. 7.

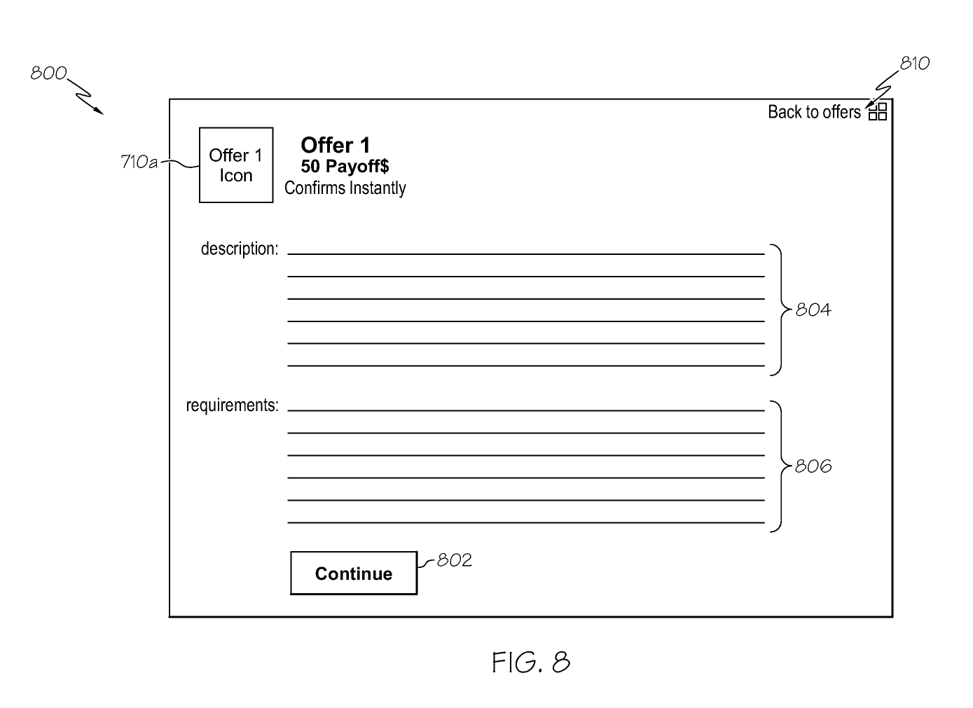

Upon manipulating any of the displayed incentive activities (e.g., by clicking on the displayed debt reduction amount, the incentive icon, etc.), an offer details screen may be displayed. For example, upon manipulating first incentive activity 710, offer details screen 800 may be displayed, as indicated in FIG. 8. The offer details screen 800 may include a description section 804, which describes the incentive activity, and a requirements section 806, which details the requirements necessary to successfully complete the incentive activity. The offer details screen 800 may also include a “continue” button 802, which may allow a user to participate in the incentive activity.

In one embodiment, in response to selecting the displayed incentive activity, the user may be redirected to a website associated with the incentive provider, such as a website administered by the optional incentive provider computing system 14, which may be a direct incentive activity/offer provider or an aggregator of incentive activities/offers. Upon successful completion of the incentive activity, the optional incentive provider computing system 14 may transmit an incentive completion confirmation message indicative of the incentive activity being successfully completed. The debt reduction facilitation computing system 12 may then automatically receive the incentive completion confirmation message and automatically facilitate the reduction of the outstanding debt balance, as described hereinabove (e.g., by reducing the outstanding balance stored in a non-transitory memory component of the debt reduction facilitation computing system 12 by the debt reduction amount or automatically transmitting a debt reduction message).

It should now be understood that the embodiments described herein provide for systems and methods for facilitating a reduction of an outstanding balance on a debt account in a debt reduction incentive program. By facilitating the reduction of an outstanding balance of a debt account by a debt reduction amount that is higher than an actual payment amount as a result of an incentive participant successfully completing an incentive activity, debtors may be motivated to pay off their debt because they may feel like they are receiving a greater benefit than if they only received the actual payment amount in cash or cash equivalents, as may be the case if the debtor participated in an incentive program outside of the debt reduction incentive program provided herein. By facilitating the reduction of an outstanding balance of a debt account by a debt reduction amount that is higher than an actual payment amount as described herein, debtors may benefit by paying off an outstanding balance of a debt account more quickly than if the outstanding balance were merely reduced by the actual payment amount. Furthermore, debtors may benefit from the ability to pay off an outstanding balance of a debt account by engaging in activity (e.g., shopping or signing up for offers), that they may ordinarily engage in. Encouraging debtors to pay off their outstanding debt by reducing the outstanding debt by a payoff amount greater than an actual payment amount may allow debt owners and/or debt collectors to receive more and/or accelerated payments on debt accounts, thereby improving the ability of the debt owners and/or debt collectors to collect outstanding debt. Furthermore, in the context of defaulted debt accounts, in which the debt reduction amount may be significantly higher than the actual payment amount, debtors may be even more motivated to pay off their debt accounts, thereby improving the ability for the debt owner or debt collector to collect the defaulted debt.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computer-implemented method of facilitating a reduction of an outstanding balance on a debt account in a debt reduction incentive program, wherein the debt reduction incentive program comprises a debtor obligated to pay the outstanding balance of the debt account, a debt owner or debt collector seeking to collect payment from the debtor, and an incentive provider, the method comprising:
determining, automatically by a debt reduction facilitation computing system, that an incentive participant has successfully completed an incentive activity;
determining, automatically by the debt reduction facilitation computing system, the debt account for which the outstanding balance will be reduced as a result of the successful completion of the incentive activity by the incentive participant;
determining, automatically by the debt reduction facilitation computing system, a debt reduction amount, wherein the debt reduction amount is based on an actual payment amount, wherein the actual payment amount is indicative of an amount of money to be actually paid to the debt owner or debt collector as a result of the incentive participant successfully completing the incentive activity, and wherein the debt reduction amount is greater than the actual payment amount; and
facilitating, automatically by the debt reduction facilitation computing system, the reduction of the outstanding balance of the debt account by the debt reduction amount.

2. The method of claim 1, wherein the debt reduction amount is determined by multiplying the actual payment amount by a payoff enhancement factor.

3. The method of claim 2, wherein the payoff enhancement factor is based on at least one of the outstanding balance, the debt account, the debtor, the debt owner or debt collector, and a collection status of the debt account.

4. The method of claim 1, wherein the reduction of the outstanding balance of the debt account by the debt reduction amount is facilitated by transmitting, automatically by the debt reduction facilitation computing system, a debt reduction message after determining that the incentive participant successfully completed the incentive activity.

5. The method of claim 4, wherein the reduction of the outstanding balance of the debt account is facilitated by receiving, automatically by a debt account administration computing system, the transmitted debt reduction message, and reducing, automatically by the debt account administration computing system, the outstanding balance of the debt account in response to receiving the debt reduction message.

6. The method of claim 4, wherein the debt reduction message includes: (i) the incentive activity; (ii) the actual payment amount; or (iii) the debt reduction amount.

7. The method of claim 4 the method further comprising determining, automatically by the debt reduction facilitation computing system, a program administration fee, wherein the debt reduction amount is based on the actual payment amount less the program administration fee.

8. The method of claim 1, wherein the debt reduction facilitation computing system comprises a non-transitory memory component comprising the outstanding balance, and wherein the reduction of the outstanding balance of the debt account by the debt reduction amount is facilitated by reducing, automatically by the debt reduction facilitation computing system, the outstanding balance stored in the non-transitory memory component by the debt reduction amount.

9. The method of claim 1, wherein the successful completion of the incentive activity is determined by receiving, automatically by the debt reduction facilitation computing system, an incentive completion confirmation message, wherein the incentive completion confirmation message is indicative of the incentive activity being successfully completed, wherein the outstanding balance is reduced by the debt reduction amount in response to receiving the incentive completion confirmation message.

10. The method of claim 1, wherein the successful completion of the incentive activity is determined by receiving, automatically by the debt reduction facilitation computing system, an electronic incentive payment of the actual payment amount, wherein the outstanding balance is reduced by the debt reduction amount in response to receiving the electronic incentive payment.

11. The method of claim 1, the method further comprising receiving, automatically by the debt reduction facilitation computing system, debt account data, wherein the debt account data includes a promotional code, a debtor identification code, a Social Security number of the debtor, a name of the debtor, an address of the debtor, a telephone number of the debtor, or a debt account number, wherein the debt account associated with the incentive activity is determined based on the received debt account data.

12. The method of claim 1, wherein the debt reduction amount exceeds the actual payment amount by a payoff enhancement amount, wherein the payoff enhancement amount is based on at least one of the outstanding balance, the debt account, the debtor, the debt owner or debt collector, and a collection status of the debt account.

13. A computer-implemented method for facilitating a reduction of an outstanding balance on a debt account in a debt reduction incentive program, wherein the debt reduction incentive program comprises a debtor obligated to pay the outstanding balance of the debt account, a debt owner or debt collector seeking to collect payment from the debtor, and an incentive provider, the method comprising:
receiving, automatically by a debt reduction facilitation computing system, debt account data;
determining, automatically by the debt reduction facilitation computing system, the debt account for which the outstanding balance will be reduced as a result of the successful completion of an incentive activity by the incentive participant based on the received debt account data; and
providing for display, automatically by the debt reduction facilitation computing system, a graphical representation of the incentive activity and a debt reduction amount, wherein the debt reduction amount is based on the actual payment amount, wherein the actual payment amount is indicative of an amount of money to be actually paid to the debt owner or debt collector as a result of the incentive participant successfully completing the incentive activity, and wherein the debt reduction amount is greater than the actual payment amount.

14. The method of claim 13, wherein the debt reduction amount is determined by multiplying the actual payment amount by a payoff enhancement factor.

15. The method of claim 13, wherein the payoff enhancement factor is based on at least one of the outstanding balance, the debt account, the debtor, the debt owner or debt collector, and a collection status of the debt account.

16. The method of claim 13, wherein the debt account is a defaulted debt account.

17. The method of claim 13, the method further comprising:
in response to selection of the displayed incentive activity, redirecting, automatically by the debt reduction facilitation computing system, the user to a website associated with the incentive provider;
receiving, automatically by the debt reduction facilitation computing system, an incentive completion confirmation message, wherein the incentive completion confirmation message is indicative of the incentive activity being successfully completed; and
reducing, automatically by the debt reduction facilitation computing system, the outstanding balance stored in a non-transitory memory component of the debt reduction facilitation computing system by the debt reduction amount.

18. The method of claim 13, the method further comprising:
in response to selection of the displayed incentive activity, redirecting, automatically by the debt reduction facilitation computing system, the user to a website associated with the incentive provider;
receiving, automatically by the debt reduction facilitation computing system, an incentive completion confirmation message, wherein the incentive completion confirmation message is indicative of the incentive activity being successfully completed; and
in response to receiving the incentive completion confirmation message, transmitting, automatically by the debt reduction facilitation computing system, a debt reduction message.

19. A debt reduction facilitation computing system for facilitating a reduction of an outstanding balance on a debt account in a debt reduction incentive program, wherein the debt reduction incentive program comprises a debtor obligated to pay the outstanding balance of the debt account, a debt owner or debt collector seeking to collect payment from the debtor, and an incentive provider, the system comprising:
a non-transitory memory component storing a set of executable instructions and a processor capable of executing the set of executable instructions, wherein, when executed by the processor, the set of executable instructions causes the debt reduction facilitation computing system to:
determine, automatically, that an incentive participant has successfully completed an incentive activity;
determine, automatically, the debt account for which the outstanding balance will be reduced as a result of the successful completion of the incentive activity by the incentive participant;
determine, automatically, a debt reduction amount, wherein the debt reduction amount is based on an actual payment amount, wherein the actual payment amount is indicative of an amount of money to be actually paid to the debt owner or debt collector as a result of the incentive participant successfully completing the incentive activity, and wherein the debt reduction amount is greater than the actual payment amount; and
facilitate, automatically, the reduction of the outstanding balance of the debt account by the debt reduction amount.

20. The system of claim 19, wherein the debt reduction amount is determined by multiplying the actual payment amount by a payoff enhancement factor, wherein the payoff enhancement factor is based on at least one of the outstanding balance, the debt account, the debtor, the debt owner or debt collector, and a collection status of the debt account.
